(19) United States
(12) Patent Application Publication
(10) Pub. No.: US 2015/0127419 A1
(43) Pub. Date: May 7, 2015

(54) ITEM-TO-ITEM SIMILARITY GENERATION

(71) Applicant: Oracle International Corporation, Redwood Shores, CA (US)

(72) Inventors: Sandeep TIWARI, Cambridge, MA (US); Su-Ming WU, Waltham, MA (US)

(73) Assignee: ORACLE INTERNATIONAL CORPORATION, Redwood Shores, CA (US)

(21) Appl. No.: 14/070,871

(22) Filed: Nov. 4, 2013

(51) Int. Cl. G06Q 30/02; G06F 17/30

(52) U.S. Cl. CPC G06Q 30/0201; G06F 17/3053
USPC 705/7.29

(57) ABSTRACT

A system that generates an item-to-item similarity for a category that includes a plurality of products receives attribute values for each product in the category and product-store-week sales units for each product in the category. The system estimates attribute weights. The system then determines the item-to-item similarity as a weighted attribute match score.

### FIELD

One embodiment is directed generally to a computer system, and in particular to a computer system that generates item-to-item similarities.

### BACKGROUND INFORMATION

“Category management” is a retailing concept in which the range of products sold by a retailer is broken down into discrete groups of similar or related products. These groups are referred to as “product categories”. Examples of product categories for a grocery store include yogurt, coffee, toothpaste, paper towels, etc.

Within each product category, there is a need to quantify item-to-item similarity, or substitutability. Item-to-item similarity is the perception of customers on how similar or substitutable the group of items are. Similarity is defined for a pair of items within a same category and hence it is believed that customers will tend to substitute between similar items.

Although similarities are basically associated with a customer, the modeling at a customer level may not be useful for many practical applications. This is because individual customer transaction rates may be too low to generate enough data to accurately model behavior. Therefore, there is a need to model similarities at least at an aggregate “customer segment” level. Consequently, it is assumed that customers belonging to the same customer segment tend to have a common perception of similarities between product pairs.

### SUMMARY

One embodiment is a system that generates an item-to-item similarity for a category that includes a plurality of products. The system receives attribute values for each product in the category and product-store-week sales units for each product in the category. The system estimates attribute weights. The system then determines the item-to-item similarity as a weighted attribute match score.

### BRIEF DESCRIPTION OF THE DRAWINGS

FIG. 1 is a block diagram of a computer server/system in accordance with an embodiment of the present invention.

FIG. 2 is a flow diagram of the functionality of the item-to-item similarity module of FIG. 1 when generating transaction-based similarities between two products, A and B, in accordance with one embodiment.

FIG. 3 is a flow diagram of the functionality of the item-to-item similarity module of FIG. 1 when generating attribute-based similarity for a category C in accordance with one embodiment.

FIG. 4 is a flow diagram of the functionality of the item-to-item similarity module of FIG. 1 when generating an estimation of attribute weights for an attribute Q in accordance with one embodiment.

FIG. 5 is a flow diagram of the functionality of the item-to-item similarity module of FIG. 1 when generating similarities using a hybrid approach in accordance with one embodiment.

### DETAILED DESCRIPTION

One embodiment is a system that determines item-to-item similarity, in particular when customer linked transaction history is unavailable or inadequate. The products are compared based on attributes/content, and a weight of the attribute is determined. Further, the weighted attribute determination can be combined with any available transaction history in another “hybrid” embodiment.

The determination of item-to-item similarity is critical to many business processes. For example, the choices customers make to select a product when faced with an assortment of items in a category can be represented visually as a top-down tree, with the most significant attributes (e.g., brand, flavor, and size) in descending order. An item-to-item similarity matrix is provided as a key input to generate this tree, referred to as a “Consumer Decision Tree” (“CDT”).

Further, item-to-item similarity is used as an input to determine the “demand transference” effect that will result from adding or removing stock keeping units (“SKUs”) from a store's assortment. For example, removing an SKU from a store's assortment will usually mean that some fraction of the customers who were purchasing that SKU will choose to purchase a similar SKU from the same store. Thus, a portion of the demand for the removed SKU transfers to the SKUs remaining in the assortment at the store. For example, in the “yogurt” category, if the category manager were to remove from the assortment the strawberry flavor of a particular brand of yogurt, many (but likely not all) consumers who were purchasing the removed yogurt could decide to purchase the strawberry flavor of another brand as a replacement, the replacement yogurt being in their minds similar enough to the removed yogurt that they are willing to switch instead of walking away from the store with no strawberry yogurt at all. Thus, the demand for the removed SKU consists of two parts: demand that will transfer to the remaining SKUs in the assortment, and lost demand, representing loss of demand from those shoppers who cannot find a SKU in the assortment that is similar enough to the removed SKU.

Further, systems that determine optimal product prices may use item-to-item similarity to determine “cross effects” which refers to how changing prices for one product can affect sales of another product (i.e., either decrease or increase). The cross effects are easier to calculate if the similarities are known, because the similarities give a clue as to which other products a price change will affect. Specifically, a price change will affect the other products which are similar to the product whose price is changing.

The calculated cross effects will appear more reasonable to the user, in that price changes will affect items that are similar instead of items that are totally dissimilar. Without using similarities to guide the calculation of cross effects, it is entirely possible that the calculation will produce results where sales of Item B changes when the price of Item A changes, even though A and B have no obvious connection.

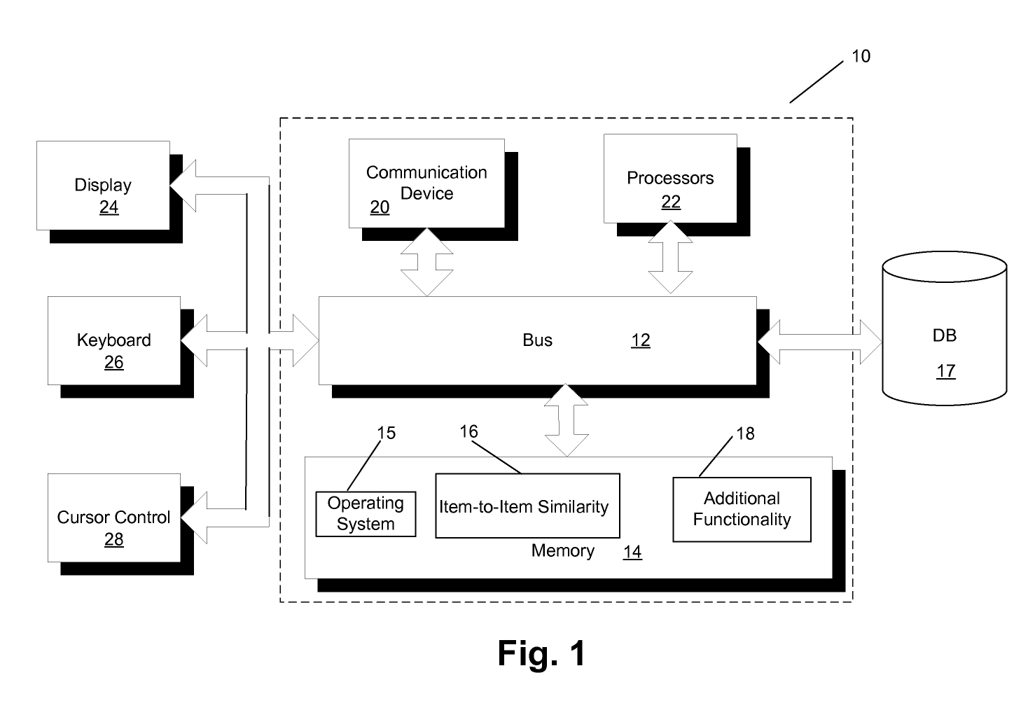

FIG. 1 is a block diagram of a computer server/system 10 in accordance with an embodiment of the present invention. Although shown as a single system, the functionality of system 10 can be implemented as a distributed system. Further, the functionality disclosed herein can be implemented on separate servers or devices that may be coupled together over a network. Further, one or more components of system 10 may not be included. For example, for functionality of a user client, system 10 may be a smartphone that includes a processor, memory and a display, but may not include one or more of the other components shown in FIG. 1.

System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network, or any other method.

Computer readable media may be any available media that can be accessed by processor 22 and includes both volatile and nonvolatile media, removable and non-removable media, and communication media. Communication media may include computer readable instructions, data structures, program modules, or other data in a modulated data signal such as a carrier wave or other transport mechanism, and includes any information delivery media.

Processor 22 is further coupled via bus 12 to a display 24, such as a Liquid Crystal Display (“LCD”). A keyboard 26 and a cursor control device 28, such as a computer mouse, are further coupled to bus 12 to enable a user to interface with system 10.

In one embodiment, memory 14 stores software modules that provide functionality when executed by processor 22. The modules include an operating system 15 that provides operating system functionality for system 10. The modules further include an item-to-item similarity module 16 for determining item-to-item similarities, and all other functionality disclosed herein. System 10 can be part of a larger system. Therefore, system 10 can include one or more additional functional modules 18 to include the additional functionality, such as “Retail Demand Forecasting” from Oracle Corp. A database 17 is coupled to bus 12 to provide centralized storage for modules 16 and 18. In one embodiment, item-item similarities are determined by module 16 using a “transaction-based” approach, an “attribute-based” approach, or a “hybrid” approach.

### Transaction-Based Determination

Assuming there is enough customer-linked transaction data available, one embodiment determines similarity by analyzing the complete transaction history of individual customer in a given category (referred to as a “transaction-based determination”). These similarity values are then rolled up to customer segment level.

In general, if two items are perceived similar by a customer, the customer might be willing to substitute one for another. Observed substitution can be used as a proxy for similarity. When the group of items are purchased by the same customer, as observed in the customer's transaction history, the implication is that those items are substitutable or similar for that customer. The extent of similarity between the pair of items is proportional to the number of such customers who have purchased both items in their transaction history and hence willing to substitute between these items. However, if a group of products in the category are purchased by several customers in the same basket, the implication is that those items are dissimilar as those items were likely purchased together due to variety seeking behavior. The same reasoning applies in the attribute space where products are replaced by the attribute values that correspond to each product, such as brand, flavor, etc.

Embodiments may use the following input data for determining transaction-based similarities for a particular category “C”: (1) Customer-linked transactions for C; (2) Grouping of customers into customer segments; and (3) Grouping of stores into trade areas. Trade areas are geographic regions designated by a retailer for operational purpose (e.g., the greater Boston Area, Chicago, San Francisco Bay Area, etc.).

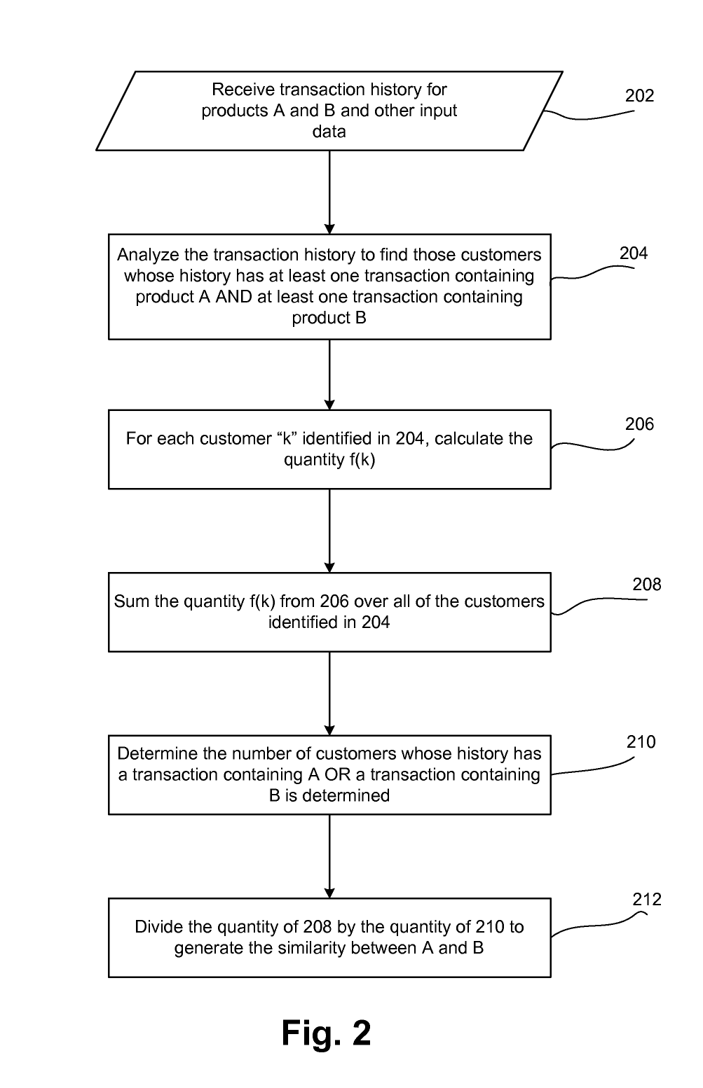

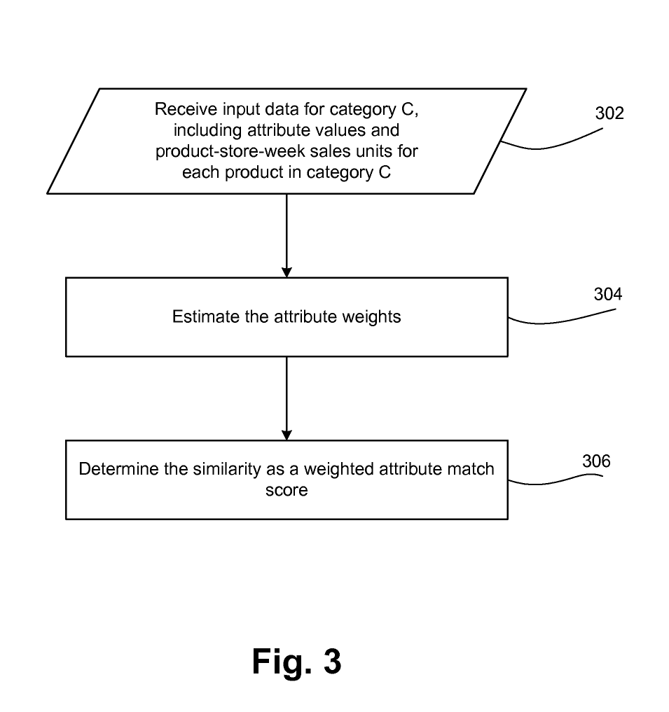

FIG. 2 is a flow diagram of the functionality of item-to-item similarity module 16 of FIG. 1 when generating transaction-based similarities between two products, A and B, in accordance with one embodiment. In one embodiment, the functionality of the flow diagram of FIG. 2, and FIGS. 3-5 below, is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

The functionality of FIG. 2 in one embodiment is executed for each combination of segment and trade area. For each combination of segment and trade area, embodiments only use those customers who are in the specific segment, and only transactions from stores in the specific trade area. The functionality of FIG. 2 is repeated for each combination of segment and trade area.

At 202, the transaction history for products A and B and other input data described above is received.

At 204, the transaction history is analyzed to find those customers whose history has at least one transaction containing product A AND at least one transaction containing product B.

At 206, for each customer “k” identified in 204, the quantity f(k) is calculated using the following:

$$\begin{matrix}f ( k ) = \frac{\begin{matrix}Number of transactions in which \\ customer bought A \& B separately\end{matrix}}{\begin{matrix}Number of transactions in which \\ customer bought either A or B\end{matrix}} \\ = 1 - \frac{\begin{matrix}Number of transactions in which \\ customer bought A \& B together\end{matrix}}{\begin{matrix}Number of transactions in which \\ customer bought either A or B\end{matrix}} .\end{matrix}$$

At 208, the quantity f(k) from 206 is summed over all of the customers identified in 204.

At 210, the number of customers whose history has a transaction containing A OR a transaction containing B is determined.

At 212, the quantity of 208 is divided by the quantity of 210 to generate the similarity between A and B. The result at 212 is as follows:

$$Product \text{/} Attribute Similarity = \frac{{\sum }_{Customers} F * f}{\# of customers who buy A or B}$$

Where A and B can be products or attribute values corresponding to any given attribute, and F=1 if a customer has bought both A and B at least once in the transaction history, 0 otherwise.

The functionality of FIG. 2 is performed for each pair of products in the category C. This gives similarities between all pairs of products of C for a specific combination of customer segment and trade area. The functionality is repeated for each combination of segment and trade area. The totality of calculated similarities is then sent to an application that require similarities, such as a retail sales forecast system or a consumer decision tree generation system.

### Attribute-Based Determination

When the customer linked transaction history is unavailable or otherwise inadequate, embodiments compare product's attributes/content. The most basic approach for similarity estimation would be to estimate the percentage of attributes that match between product pairs. However, under most scenarios, different attributes have different levels of significance in driving a customer's perception of product similarity, as shown by a CDT. Therefore, embodiments require a weighted attribute match score between the product pair, the weights being proportional to the significance of the corresponding attribute in driving product differences.

FIG. 3 is a flow diagram of the functionality of item-to-item similarity module 16 of FIG. 1 when generating attribute-based similarity for a category C in accordance with one embodiment.

At 302, the input data for category C is received. The input data may include: (1) Attribute values for each product in category C; (2) Product-store-week sales units for each product in category C; (3) Trade areas; (4) Sales units data by segment (i.e., (2) above for each segment); and (5) The assortment of a given store on a given week (i.e., the weekly assortment by store).

At 304, the attribute weights are estimated, as disclosed in detail below.

At 306, the similarity as a weighted attribute match score is determined, as disclosed in more detail below.

As with the transaction-based similarities, the functionality of FIG. 3 is executed for each combination of segment and trading area. Further, for each segment-trade area combination, only sales data for the particular segment and particular stores in the trade area is used.

As disclosed above, attribute weights are estimated at 304. The weighting functionality in one embodiment is based on an assumption that if the customers do not care about any particular attribute, then its sales share distribution should be identical to that of assortment share distribution due to random purchasing behavior. The extent of deviation of sales share distribution from assortment share distribution for any particular attribute is a good measure of significance of that particular attribute.

“Sales Share” of any attribute value is the share of sales contributed by that attribute value to the overall category sales. “Assortment Share” of any attribute value is the fraction of items in the assortment belonging to that attribute value. The distribution of sales shares and assortment shares across all the attribute values for the given attribute is referred to as “Sales Share Distribution” and “Assortment Share Distribution”, respectively, for that attribute. These distributions are represented as vectors with each element corresponding to share of a particular attribute value.

For each attribute, embodiments obtain sales share distribution and assortment share distribution vectors as described earlier. Further, because share distributions are expected to vary by time and store, such vectors are generated for each store and time period. Embodiments then calculate for each attribute the deviation between sales share and assortment share vectors at each store and time period. The deviation between sales share distribution and assortment share distribution vectors can be estimated as a Mean Absolute Deviation (“MAD”), a Root Mean Square Difference (“RMS”), an Entropy function, a KL Divergence, etc. These deviation numbers are then aggregated/averaged over a time period to obtain a single deviation number for each store and attribute.

Embodiments then calculate the weighted average of deviation values across groups of stores with net store sales as a weight for the store. This provides a single deviation value for an attribute. These deviation values are then normalized such that the deviation values over all attributes sum up to 1 to arrive at the final weights.

In mathematical terms, the formulation of the attribute weights in one embodiment are as follows:

$$Final deviation value , D \text{:} D = \frac{{\sum }_{k} ( {S}_{k} \times ( \frac{{\sum }_{∀ j} {D}_{j , k}}{{J}_{k}} ) )}{{\sum }_{k} {S}_{k}} \qquad ( 1 )$$

### j: Time Period;

### k: Store;

D_{j,k}: Deviation between the assortment and sales share vectors for store “k” and time period “j”;
Sₖ: Net sales of store (aggregated over complete history);
Jₖ: Number of time periods in a given store.

$$The weight of {q}^{th} attribute is \text{:} {W}_{q} = \frac{{D}_{q}}{{\sum }_{∀ q} {D}_{q}} \qquad ( 2 )$$

where D_{q} is deviation for q^{th} attribute.

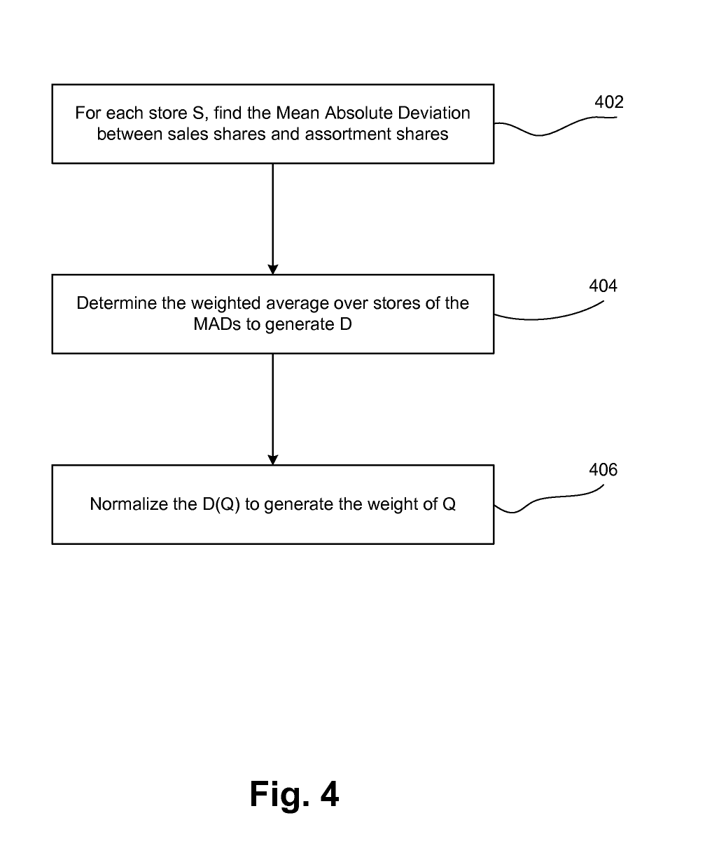

FIG. 4 is a flow diagram of the functionality of item-to-item similarity module 16 of FIG. 1 when generating an estimation of attribute weights (i.e., the functionality of 304 of FIG. 3) for an attribute Q in accordance with one embodiment.

At 402, for each store S, the Mean Absolute Deviation between sales shares and assortment shares is found.

At 404, the weighted average over stores of the MADs is determined, where the weight for each store is the total historical sales units in category C. This resulting value is the value “D” disclosed above in formula 1.

At 406, the D(Q) using formula 2 disclosed above is normalized. The result is the weight of Q.

The following example illustrates shares calculation and estimation of deviation in accordance with one embodiment:

### 1. Calculation of Market Share:

The sales share of an attribute value is its percentage contribution to overall category sales. For example, if net sales of strawberry flavored yogurt items is 100 units and net sales of the yogurt category is 500 units, the sales share of strawberry flavor=(100/500)*100=20%. The sales shares of attribute values for a given attribute type should sum up to 100. For example, if there was only one more flavor besides strawberry, such as vanilla, then the sales share of vanilla will be 100−20=80%.

### 2. Calculation of Assortment Share:

The assortment share of an attribute value is defined as a percentage of SKUs in the assortment of a given category which belongs to that particular attribute value. For example, if there are 100 Yogurt SKUs in the assortment and 40 of them are strawberry flavor, then the assortment share of the strawberry flavor will be (40/100)*100=40%.

### 3. Measure of Deviation:

Each attribute has its assortment share vector and sales share vector for each store (k) and time period (j). Each element of these vectors corresponds to a particular attribute value. Deviation (Dⱼₖ) between the assortment and sales share vectors for store “k” and time period “j” can be expressed in terms of Mean Absolute Deviation (“MAD”). It is further illustrated by the following example:

### Attribute: Brand

### Attribute Values: Dannon (D), Yoplait (Y) and Chobani (C)

| | D | Y | C |
|---|---|---|---|
| Market share vector: | [30 | 30 | 40] |
| Assortment share vector: | [60 | 20 | 20] |

Dⱼₖ=(|30−60|+|30−20|+|40−20|)/3=20.

As disclosed above, similarity values as a weighted attribute match score are determined at 306 of FIG. 3. The similarity between products A and B can be obtained using the following:

$${Sim}_{A - B} = {\sum }_{∀ q} ( {w}_{q} \times δ ( A = B ) ) \qquad ( 3 )$$

### Where,

δ(A=B)=1 if A=B and 0 otherwise
w_{q}=Weight of q^{th} attribute.

The following is an example of one embodiment in determining the similarity value between two different yogurt SKUs A and B with attribute weights pre-calculated:

| SKU | Brand | Flavor | Size |
|---|---|---|---|
| A | Yoplait | Strawberry | M |
| B | Dannon | Vanilla | M |

| Attribute | Weight |
|---|---|
| Brand | 0.4 |
| Flavor | 0.2 |
| Size | 0.4 |

Similarity=(0.4*0+0.2*0+0.4*1)=0.4

Given two products A and B from the category C, the determined weights D(Q) are used to calculate the similarity of A and B using formula 3 above. The calculation is done for all pairs of products from the category C, thus obtaining similarities for all product pairs. The similarities are then sent to an application that require similarities, such as a retail sales forecast system or a consumer decision tree generation system.

### Hybrid Determination

Transaction-based similarities are believed to be more accurate than attribute-based similarities as it uses more granular sales data. However, the transaction-based embodiment, as disclosed above, typically is not used as a stand-alone basis under the following scenarios of data insufficiency:

1. When few items do not have any transaction history; or

2. When few items do not have enough exposure in terms of time and stores. For example, items that are carried only for one quarter or items that are carried in only few stores.

In such scenarios, one embodiment uses a “hybrid” approach that determines similarities on the basis of transactions as well as product attributes. In general, the hybrid embodiment estimates similarities using the transaction-based approach disclosed above only on a subset of items that have comprehensive coverage (both from time and location perspective). Embodiments then build a predictive model of product similarity as a function of corresponding attribute similarities by fitting the model on transaction-based similarities of the subset of items. The predictive model is built in one embodiment using non-linear models such as support vector machines (“SVM”). In another embodiment, the predictive model is built using similarity extrapolation through like items (i.e., a “Like-Item” approach).

For the Non-linear/SVM embodiment, the SVM model is trained on the results from the transaction-based subset of items. Embodiments then apply the model on the left out items and obtain similarities among all the remaining product pairs. One embodiment uses a radial kernel for SVM. Other embodiments use different non-linear models, including a neural network, logistic regression, log-linear, etc.

For the similarity extrapolation through like items embodiments, the input can be a set of “existing similarities,” which can be from any source, rather than using transaction-based similarities. The following formulation is used in one embodiment: Suppose E is a set of SKUs that already possess similarities, meaning a set “SIM” of similarities where every pair of SKUs from E has a similarity specified in SIM. Suppose S is a set of SKUs containing E and having additional SKUs for which SIM does not specify similarities. Finally, for every SKU in S, attribute values are available.

Let the set N be S−E, namely those SKUs in S that do not have similarities in SIM.

The goal is to add to SIM the following additional sets of similarities:

1. Similarities between SKUs in N and SKUs in E.

2. Similarities between the SKUs in N.

Thus, SIM will have a complete set of similarities for S.
The approach is to identify for each SKU in N a set of “like items” in E. The determination is as follows as shown by the below two cases.

Case 1:

Suppose s is an SKU in N. Find its 5 “most similar” SKUs of E, e₁, . . . , e₅, using attribute-based similarity. These are the “like items” of s. (Since for SKUs in N only their attribute values are available, attribute-based similarity is used to find the like items.)

Now suppose e is an SKU of E. Define the similarity between s and e is as follows:

$$sim ( s , e ) = \frac{{\sum }_{{e}_{i} \neq e} {sim}_{a} ( s , {e}_{i} ) \cdot {sim}_{e} ( {e}_{i} , e )}{{\sum }_{{e}_{i} \neq e} {sim}_{a} ( s , {e}_{i} )}$$

simₐ indicates “attribute-based similarity,” while simₑ indicates similarity from SIM. Therefore, sim(s,e) is really just a weighted average of SIM-based similarities, where the weight is the attribute-based similarity between s and eᵢ. Note that the summations run over eᵢ≠e, because in the case where one of the eᵢ happens to be e itself, it should not be included in the sum.

Case 2:

This is similar to case 1, as it is again a weighted average. Suppose s and t are two SKUs in N. Find the 5 most similar SKUs e₁, . . . , e₅ in E to s, and the 5 most similar SKUs f₁, . . . , f₅ in E to t, again using attribute-based similarity. Now take the weighted average over the indices i, j:

$$sim ( s , t ) = \frac{{\sum }_{{e}_{i} \neq {f}_{j}} {sim}_{a} ( s , {e}_{i} ) \cdot {sim}_{e} ( {e}_{i} , {f}_{j} ) \cdot {sim}_{a} ( {f}_{j} , t )}{{\sum }_{{e}_{i} \neq {f}_{j}} {sim}_{a} ( s , {e}_{i} ) \cdot {sim}_{a} ( {f}_{j} , t )}$$

Again, note that the summations are over eᵢ≠fᵢ. This is like case 1, except that the weights come from both s and t. The summations contain at most 25 terms, since there are 5 similarities for s and 5 for t.

For the like-item similarity embodiment, because the new similarities are derived as weighted averages of similarities in SIM, the new similarities will have magnitudes that are roughly on a par with the ones in SIM. Therefore, the new similarities will not be grossly out of line with the ones already in SIM.

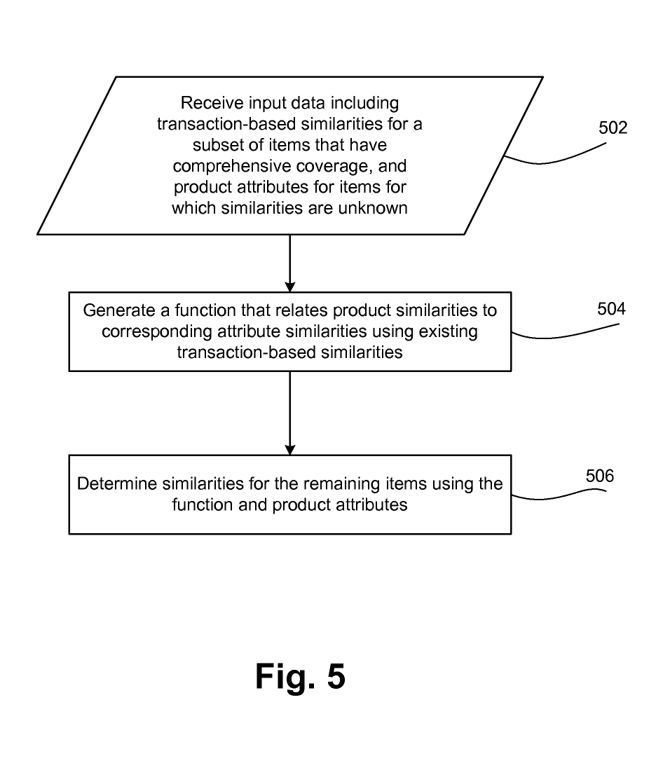

FIG. 5 is a flow diagram of the functionality of item-to-item similarity module 16 of FIG. 1 when generating similarities using a hybrid approach in accordance with one embodiment.

At 502, input data is received. The input data includes transaction-based similarities for a subset of items that have comprehensive coverage, and product attributes for items for which similarities are unknown (i.e., cannot be determined using the transaction-based approach due to lack of data). The transaction-based similarities are generated as disclosed in conjunction with FIG. 2 above.

At 504, the function that relates product similarities to corresponding attribute similarities using existing transaction-based similarities is generated. The function in one embodiment is a predictive model of product similarity as a function of corresponding attribute similarities generated by fitting the model on transaction-based similarities of the subset of items.

At 506, the function and product attributes are used to obtain similarities for the remaining items. The function is loaded with pairs of products, along with the attribute values for each product, where at least one product in the pair is a “new” product (i.e., a product in the set N described above). The similarities are then sent to an application that require similarities, such as a retail sales forecast system or a consumer decision tree generation system.

### Validation of Similarity Values

Embodiments can assess the accuracy/quantity of similarity values, in order to validate similarities before being used downstream. The validation is based on the idea that similar items will have similar sales shares in same store for a given customer segment (or entire store if segments are not available).

One embodiment validates similarity values by determining a correlation between similarity values and share difference. The difference in store shares (store segment shares if segments are available) of two items within a particular customer segment (Share Difference SD) is negatively correlated to the similarity between these two items as perceived by that customer segment. Specifically, the share difference between items A and B is:

$${SD}_{AB} = {\sum }_{∀ k} {\sum }_{∀ t} {( {Share}_{A , c , k , t} - {Share}_{B , c , k , t} )}^{2}$$

$$Where$$

$${Share}_{A , c , k , t} = \frac{\begin{matrix}Sales unit of item A within customer \\ segment C in store k at time t\end{matrix}}{\begin{matrix}Total sales units of the category within \\ customer segment in store k at time t\end{matrix}}$$

$${Share}_{B , c , k , t} = \frac{\begin{matrix}Sales unit of item B within customer \\ segment C in store k at time t\end{matrix}}{\begin{matrix}Total sales units of the category within \\ customer segment in store k at time t\end{matrix}}$$

The extent of negative correlation between Similarity values and Share Difference for a pair of items is the measure of accuracy for similarities.

Another embodiment validates by determining the accuracy of new item demand forecasting model using similarities. Sales of a new item can be estimated as a weighted average of sales of all other items in the store where weight is the extent of similarity between the new item and the other item:

$${S}_{i , k} = \frac{{\sum }_{i \neq j} ( {Sim}_{i , j} \times {S}_{j , k} )}{{\sum }_{i \neq j} ( {Sim}_{i , j} )}$$

The accuracy of this model hinges on the accuracy of similarities itself. Therefore, the accuracy of similarity values is proportional to the accuracy of forecasting model. The accuracy of the forecasting model is measured in the following way in one embodiment: All historical Item-locations are divided hypothetically into existing item-location (training set—70%) and new item-locations (test set—30%). The predicted demand for new item-locations is obtained by applying models built on existing item-locations. The Mean Absolute Percentage Error (“MAPE”) and Weighted Absolute Percentage Error (“WAPE”) can be used to quantify deviation between actual and predicted values as the accuracy measure.

As disclosed, embodiments determine item-to-item similarities using a variety of methods, depending on the available transaction data. The transaction-based approach can be used when customer linked transaction data is available for items under consideration. The attribute-based approach can be used when aggregate sales data, assortment information, and good product attributes are available. The hybrid approach can be used when customer linked transaction data with insufficient or no transaction history for a few items, and product attribute information, is available. Embodiments can validate the similarities so that it can be reliably used in downstream applications such as product sales forecasting, the generation of CDTs, and demand transference determinations.

Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A computer-readable medium having instructions stored thereon that, when executed by a processor, cause the processor to generate an item-to-item similarity for a category comprising a plurality of products, the generating comprising:
receiving attribute values for each product in the category and product-store-week sales units for each product in the category;
estimating attribute weights; and
determining the item-to-item similarity as a weighted attribute match score.

2. The computer-readable medium of claim 1, the estimating attribute weights comprising:
for each store, determining a Mean Absolute Deviation (MAD) between sales shares and assortment shares;
determining a weighted average over stores of the MADs, wherein a weight for each store is a total historical sales units in the category; and
normalizing the weighted average over stores of the MADs.

3. The computer-readable medium of claim 1, further comprising:
generating transaction-based item-to-item similarities for a subset of items that have comprehensive coverage; and
generating a function that relates product similarities to corresponding attribute similarities.

4. The computer-readable medium of claim 3, wherein the function comprises a predictive model of product similarity as a function of corresponding attribute similarities generated by fitting the model on transaction-based similarities of the subset of items.

5. The computer-readable medium of claim 3, wherein the generating transaction-based item-to-item similarities comprises, for products A and B:
analyzing a transaction history of products A and B and identifying customers with at least one transaction containing product A and at least one transaction containing product B; and
for each identified customer calculating a quantity f(k), wherein
$$f ( k ) = \frac{\begin{matrix}Number of transactions in which customer \\ bought A \& B seperately\end{matrix}}{\begin{matrix}Number of transactions in which \\ customer bought either A or B\end{matrix}} .$$

6. The computer-readable medium of claim 1, wherein the estimating attribute weights comprises:
determining a final deviation value
$$D = \frac{{\sum }_{k} ( {S}_{k} \times ( \frac{{\sum }_{∀ j} {D}_{j , k}}{{J}_{k}} ) )}{{\sum }_{k} {S}_{k}} ,$$
wherein j is a time period, k is a store, D_{j,k} is a deviation between an assortment and sales share vectors for store k and time period j, Sₖ is net sales of the store, and Jₖ is a number of time periods in a given store, wherein the weight of q^{th} attribute is:
$${W}_{q} = \frac{{D}_{q}}{{\sum }_{∀ q} {D}_{q}} ,$$
wherein D_{q} is a deviation for q^{th} attribute.

7. The computer-readable medium of claim 1, wherein determining the item-to-item similarity as the weighted attribute match score comprises, for the similarity between products A and B:
$${Sim}_{A - B} = {\sum }_{∀ q} ( {w}_{q} \times δ ( A = B ) ) ,$$
wherein δ(A=B)=1 if A=B and 0 otherwise, and w_{q}=weight of q^{th} attribute.

8. The computer-readable medium of claim 1, comprising using the item-to-item similarity to generate at least one of a Consumer Decision Tree, a demand transference effect, or a sales forecast.

9. A method of generating an item-to-item similarity for a category comprising a plurality of products, the method comprising:
receiving attribute values for each product in the category and product-store-week sales units for each product in the category;
estimating attribute weights; and
determining the item-to-item similarity as a weighted attribute match score.

10. The method of claim 9, the estimating attribute weights comprising:
for each store, determining a Mean Absolute Deviation (MAD) between sales shares and assortment shares;
determining a weighted average over stores of the MADs, wherein a weight for each store is a total historical sales units in the category; and
normalizing the weighted average over stores of the MADs.

11. The method of claim 9, further comprising:
generating transaction-based item-to-item similarities for a subset of items that have comprehensive coverage; and
generating a function that relates product similarities to corresponding attribute similarities.

12. The method of claim 11, wherein the function comprises a predictive model of product similarity as a function of corresponding attribute similarities generated by fitting the model on transaction-based similarities of the subset of items.

13. The method of claim 11, wherein the generating transaction-based item-to-item similarities comprises, for products A and B:
analyzing a transaction history of products A and B and identifying customers with at least one transaction containing product A and at least one transaction containing product B; and
for each identified customer calculating a quantity f(k), wherein
$$f ( k ) = \frac{\begin{matrix}Number of transactions in which customer \\ bought A \& B seperately\end{matrix}}{\begin{matrix}Number of transactions in which \\ customer bought either A or B\end{matrix}} .$$

14. The method of claim 9, wherein the estimating attribute weights comprises:
determining a final deviation value
$$D = \frac{{\sum }_{k} ( {S}_{k} \times ( \frac{{\sum }_{∀ J} {D}_{j , k}}{{J}_{k}} ) )}{{\sum }_{k} {S}_{k}} ,$$
wherein j is a time period, k is a store, D_{j,k} is a deviation between an assortment and sales share vectors for store k and time period j, Sₖ is net sales of the store, and Jₖ is a number of time periods in a given store, wherein the weight of q^{th} attribute is:
$${W}_{q} = \frac{{D}_{q}}{{\sum }_{∀ q} {D}_{q}} ,$$
wherein D_{q} is a deviation for q^{th} attribute.

15. The method of claim 9, wherein determining the item-to-item similarity as the weighted attribute match score comprises, for the similarity between products A and B:
$${Sim}_{A - B} = {\sum }_{∀ q} ( {w}_{q} \times δ ( A = B ) ) ,$$
wherein δ(A=B)=1 if A=B and 0 otherwise, and w_{q}=weight of q^{th} attribute.

16. The method of claim 9, further comprising using the item-to-item similarity to generate at least one of a Consumer Decision Tree, a demand transference effect, or a sales forecast.

17. An item-to-item generation system comprising:
a processor coupled to a memory device that stores instructions that generate an estimating module and a determining module when executed by the processor;
the estimating module receiving attribute values for each product in a category of products and product-store-week sales units for each product in the category and estimating attribute weights; and
the determining module determining the item-to-item similarity as a weighted attribute match score.

18. The system of claim 17, the estimating attribute weights comprising:
for each store, determining a Mean Absolute Deviation (MAD) between sales shares and assortment shares;
determining a weighted average over stores of the MADs, wherein a weight for each store is a total historical sales units in the category; and
normalizing the weighted average over stores of the MADs.

19. The system of claim 17, the determining module further comprising:
generating transaction-based item-to-item similarities for a subset of items that have comprehensive coverage; and
generating a function that relates product similarities to corresponding attribute similarities.

20. The system of claim 19, wherein the function comprises a predictive model of product similarity as a function of corresponding attribute similarities generated by fitting the model on transaction-based similarities of the subset of items.
